(19) United States
(12) Patent Application Publication
(10) Pub. No.: US 2007/0247883 A1
(43) Pub. Date: Oct. 25, 2007

(54) Wireless Charging System with Feedback Loop

(76) Inventor: Oleg Valerievich Belyanin, Zhukovsky (RU)

Correspondence Address: TUNG & ASSOCIATES, Suite 120, 838 W. Long Lake Road, Bloomfield Hills, MI, 48302, US

(21) Appl. No.: 11/754,273

(22) Filed: May 26, 2007

(30) Foreign Application Priority Data
Apr. 20, 2006 (RU) 2006113376

(51) Int. Cl. H02M 7/34

(52) U.S. Cl. 363/108

(57) ABSTRACT

A wireless charging system with a feedback loop which includes on the supply side a high-frequency generator, whose input is connected to the controlling output of a controller, and whose output is connected to the first input of a modulator whose input is connected to an antenna and to the input of a decoder whose output is connected via an amplifier to the input of the controller, and the data output is connected to the second input of the modulator, and, on the side of the charging unit, another antenna connected to the output of the modulator and to the inputs of a decoder and an inverter, whose outputs are connected respectively to the data and energy inputs of the charge-discharge controller which is connected to a storage battery and/or to an supercapacitor unit, the data and the controlling outputs of the charge-discharge controller being connected respectively to the first input of the modulator and to the input of the generator, whose output is connected to the second input of the modulator, wherein the inverter includes a rectifier and a voltage multiplier connected in series.

### FIELD OF THE INVENTION

The present invention relates to electrical engineering and is intended to ensure transmission of electric power and information to wireless devices, such as keyboards, computer mice, mobile telephones, photo-, video- and web-cameras, pocket computers, active RFID markers, wireless control consoles, data input units and any other low-power wireless devices.

### BACKGROUND OF THE INVENTION

Known in the art are wireless electric power transmission systems based on the reception of electromagnetic oscillations from the air (WO 2005069503 28.07.2005 H02 J 17/00, JP 2005537773T 08.12.2005 H02 J 17/00, U.S. 2005077872 14.04.2005 H02 J 17/00, WO 200438890 02.02.2006 H02 J 17/00 and others).

The nearest to the invention appears to be wireless power supply device WO 2006030497 23.03.2006 H02 J 17/00.

However, all aforementioned power transmission systems are deficient in that they do not allow of any adaptation in their operating conditions, thereby making it impossible to maintain the uninterrupted operation of their electricity users and to prolong the service life of their energy storage components.

It is an object of the invention to make the system adaptable to operating conditions, to ensure uninterrupted operation of its electricity users and to prolong the service life of its energy storage components.

### SUMMARY OF THE INVENTION

The above object is accomplished owing to the fact that the proposed wireless charging system with a feedback loop comprises on the supply side a high-frequency generator, whose input is connected to the controlling output of a controller, and the output is connected to the first input of a modulator whose input is connected to an antenna and to the input of a decoder whose output is connected via an amplifier to the input of the controller, and the data output is connected to the second input of the modulator, and, on the side of the charging unit, another antenna connected to the output of the modulator and to the inputs of a decoder and an inverter, whose outputs are connected respectively to the data and energy inputs of the charge-discharge controller which is connected to a storage battery and/or to an supercapacitor unit, the data and the controlling outputs of the charge-discharge controller being connected respectively to the first input of the modulator and to the input of the generator, whose output is connected to the second input of the modulator, said inverter comprising a rectifier and a voltage multiplier connected in series.

Additional features of the invention consist in that the output of the modulator and the input of the decoder on the supply side are connected to the antenna through the first isolation unit, whereas on the side of the charging unit the antenna is connected to the output of the modulator and to the inputs of the decoder and the inverter via the second isolation unit.

### BRIEF DESCRIPTION OF THE DRAWINGS

The invention will now be described, by way of example, with reference to the accompanying drawings, in which:

FIG. 1 illustrates an electrical block diagram of the wireless charging system with a feedback loop.

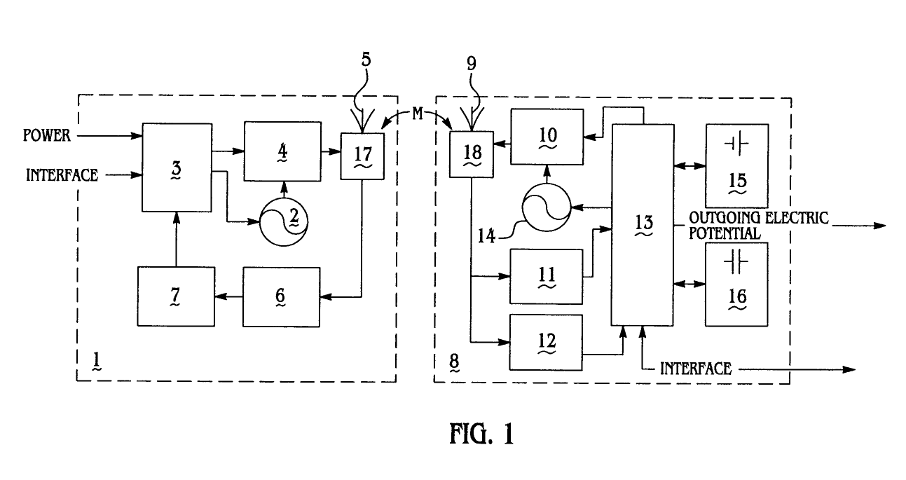

### DETAILED DESCRIPTION OF THE PREFERRED EMBODIMENT

The present invention relates to electrical engineering and is intended to ensure transmission of electric power and information to wireless devices, such as keyboards, computer mice, mobile telephones, photo-, video- and web-cameras, pocket computers, active RFID markers, wireless control consoles, data input units and any other low-power wireless devices.

It is an object of the invention to make the system adaptable to operating conditions, to ensure uninterrupted operation of its electricity users and to prolong the service life of its energy storage components.

The above object is accomplished owing to the fact that the proposed wireless charging system with a feedback loop comprises on the supply side a high-frequency generator, whose input is connected to the controlling output of a controller, and the output is connected to the first input of a modulator whose input is connected to an antenna and to the input of a decoder whose output is connected via an amplifier to the input of the controller, and the data output is connected to the second input of the modulator, and, on the side of the charging unit, the antenna connected to the output of the modulator and to the inputs of a decoder and an inverter, whose outputs are connected respectively to the data and energy inputs of the charge-discharge controller which is connected to a storage battery and/or to an supercapacitor unit, the data and the controlling outputs of the charge-discharge controller being connected respectively to the first input of the modulator and to the input of the generator, whose output is connected to the second input of the modulator, and the inverter comprising a rectifier and a voltage multiplier connected in series.

Additional features of the invention consist in that the output of the modulator and the input of the decoder on the supply side are connected to the antenna through the first isolation unit, whereas on the side of the charging unit the antenna is connected to the output of the modulator and to the inputs of the decoder and the inverter via the second isolation unit.

The wireless charging system with a feedback loop comprises on the supply side 1—high-frequency generator 2, controller 3, modulator 4, antenna 5, decoder 6, amplifier 7, and on the side of charging device 8—antenna 9, modulator 10, decoder 11, inverter 12, charge-discharge controller 13, high-frequency generator 14, storage battery 15 and supercapacitor unit 16, as well as the first and the second isolation units 17 and 18 respectively. The supply side may be connected to the parent device (for instance, to a computer) and exchange data commands with it through an interface. The charging device may exchange data commands with a mobile device through an interface.

The wireless charging system with a feedback loop operates as follows.

Antenna 5 radiates electromagnetic waves of definite frequency ω.

These waves induce in antenna 9 of the charging device an electromotive force characterized by frequency ω and an amplitude depending on the distance to the radiator.

Inverter 11 must transform AC voltage into DC voltage (which is slowly changing) or into pulsing voltage Ui which must not fall below the threshold level determined by the specific design of the charge-discharge controller and the design of the storage cells and supercapacitors used in the charging system.

Charge-discharge controller 13 is a standard element used in modern mobile devices. It serves to optimize the charge and discharge modes of storage cells and supercapacitors (in order to maintain the necessary voltages and currents and prevent full discharge), to change-over loads to charged storage cells and supercapacitors in order to maintain the necessary supply voltage, etc.

Controller 3 of the supply side controls high-frequency generator 2 by applying power on/off command signals and commands for setting a definite power level.

Controller 3 transmits commands for the side of charging device 8 through modulator 4 which modulates the carrier signal of high-frequency generator 2. The modulated signal is radiated by antenna 5 and received by antenna 9 of the side of charging device 8. The modulated component of the signal is decoded by decoder 11 and transmitted to charge-discharge controller 13 which in this case fulfils not only the aforementioned functions, but also the functions of processing and transmission of data commands.

The AC voltage from antenna 9 of the side of the charging device is rectified and amplified by the inverter to a level required for charging the storage cells and the supercapacitors.

The signal received from the side of charging device 8 is decoded by decoder 6, amplified by amplifier 7 (which is necessary, because the power of the wireless system signal is much lower than the power of the radiator signal) and applied to the input of controller 3. Controller 3 receives commands from the side of the charging device and forms on/off switching and control commands in order to energize and deenergize the power supply circuit and maintain the required power level of high frequency generator 2 (for optimizing the intensity of energy radiation), as well as commands for regulation of the operating condition of charge-discharge controller 13.

As supply voltage decreases (due to discharge of storage cells and supercapacitors), charge-discharge controller 13 forms a discharge signal and transmits it to controller 3 which forms a command to high-frequency generator 2 for increase of the carrier power (amplitude). The carrier of the transmitted signal is used for recharging the blocks of storage cells and supercapacitors 15 and 16. The carrier from high-frequency generator 4 comes to antenna 5 even if there is no transmission of data from the supply side (the modulator is not a balanced type).

Isolation units 17 and 18 serve for separation of the receiving and transmitting paths during operation of the system on one frequency (the frequencies of high-frequency generators 2 and 14 are equal).

The proposed system is capable of operation in the adaptive mode, making it possible to recharge storage cells as they are being discharged which extends their service life.

While the preferred embodiments of the invention have been described above, it will be recognized and understood that various modifications can be made in the invention and the appended claims are intended to cover all such modifications which may fall within the spirit and scope of the invention.

What is claimed is:

1. A wireless charging system with a feedback loop comprising:
a high-frequency generator on the supply side, whose input is connected to a controlling output of a controller, and whose output is connected to a first input of a modulator which has an input connected to a first antenna and an input of a first decoder, an output of said first decoder is connected via an amplifier to the input of the controller, and a data output of the controller is connected to a second input of the modulator, and
a second antenna on the side of the charging unit connected to an output of the modulator and to inputs of a second decoder and an inverter, outputs from said second decoder and said inverter are connected respectively to data and energy inputs of a charge-discharge controller which is connected to a storage battery and/or to an supercapacitor unit, the data and the controlling outputs of the charge-discharge controller being connected respectively to the first input of the modulator and to the input of the high-frequency generator, whose output is connected to the second input of the modulator, said inverter comprising a rectifier and a voltage multiplier connected in series.

2. A wireless charging system with a feedback loop according to claim 1, characterized in that the output of the modulator and the input of the decoder on the supply side are connected to the antenna via the first isolation unit, whereas on the side of the charging unit the antenna is connected to the output of the modulator and to the inputs of the decoder and the inverter via the second isolation unit.
